(19) United States
(12) Patent Application Publication
(10) Pub. No.: US 2025/0322078 A1
(43) Pub. Date: Oct. 16, 2025

(54) Broken object level authorization vulnerability detection

(71) Applicant: Palo Alto Networks, Inc., Santa Clara, CA (US)

(72) Inventors: Aviv Sasson, Petah Tikva (IL); Ravid Mazon, Kfar Saba (IL); Jay Chen, Fairfax, VA (US)

(21) Appl. No.: 18/634,946

(22) Filed: Apr. 14, 2024

(51) Int. Cl. G06F 21/57

(52) U.S. Cl. CPC G06F 21/577; G06F 2221/033

(57) ABSTRACT

Methods, storage systems and computer program products implement embodiments of the present invention for identifying a vulnerability in a software application. In these embodiments, a specification is received that includes a plurality of application programming interface (API) endpoints in the software application, and a first API endpoint of the software application that exposes user information is identified. An execution path in the software application is identified that includes an ordered sequence of two or more of the API endpoints, the ordered sequence starting with a second API endpoint and ending with the first API endpoint. An attack on the software application that exploits the identified execution path is simulated, and finally, an alert is issued when the simulated attack is found to have been successful.

### FIELD OF THE INVENTION

The present invention relates generally to computer security, and particularly to detecting a vulnerability in a software application to a broken object level authorization (BOLA) attack.

### BACKGROUND OF THE INVENTION

Broken object level authorization (BOLA) is a security vulnerability that occurs when an application or application programming interface (API) provides access to data objects based on a role of a user, but fails to verify if the user is authorized to access those specific data objects. This vulnerability allows malicious users to bypass authorization and access user information (that may comprise sensitive data) or execute unauthorized actions like manipulating (editing/deleting) other users resources, to which they would otherwise not have access.

In a BOLA attack example, an e-commerce web-based application allows users to update their account information, such as email addresses using a user identifier (ID) as the sole basis for authorization. If a flaw exists in the application's business logic regarding the email update process, the application can fail to verify whether the user attempting to change the email address actually owns the account.

An attacker can identify and exploit this vulnerability by manipulating the requests sent to the server during the email update. For example, the attacker can change the user ID in the request, thereby tricking the application into updating the email address for an account that doesn't belong to them.

As a result, the attacker can successfully change the email address associated with another user's account without proper authorization. This unauthorized action could lead to various malicious activities, such as account takeover, unauthorized access to user information and manipulation (editing/deleting) of other users' resources.

The description above is presented as a general overview of related art in this field and should not be construed as an admission that any of the information it contains constitutes prior art against the present patent application.

### SUMMARY OF THE INVENTION

There is provided, in accordance with an embodiment of the present invention, a method for identifying a vulnerability in a software application, the method including receiving a specification a application programming of plurality of interface (API) endpoints in the software application, detecting a first API endpoint of the software application that exposes user information, identifying in the software application an execution path including an ordered sequence of two or more of the API endpoints, the ordered sequence starting with a second API endpoint and ending with the first API endpoint, simulating an attack on the software application exploits the identified execution path, and issuing an alert when the simulated attack is found to have been successful.

In one embodiment, the vulnerability includes a vulnerability to broken object level authorization (BOLA) attacks, and wherein the attack includes a given BOLA attack.

In some embodiments, the specification includes an OpenAPI specification.

In another embodiment, identifying the execution path includes identifying, in the specification, dependencies between the API endpoints, generating a dependency tree based on the identified dependencies, and identifying the execution path in the dependency tree.

In these embodiments, identifying the dependencies may include applying a large language model classifier to the specification.

In an additional embodiment, simulating the attack includes generating a shell script for the software application that simulates the attack, and executing the shell script.

In a further embodiment, detecting the first API endpoint includes applying a set of rules to the specification, and detecting that a given rule applies to the first API endpoint.

In a first rule embodiment, a given rule includes detecting if an input parameter for the first API endpoint includes a universally unique identifier.

In a second rule embodiment, a given rule includes detecting second an input parameter for the first API endpoint includes a globally unique identifier.

In a third rule embodiment, a given rule includes detecting if an input parameter for the first API endpoint includes a session ID.

In a fourth rule embodiment, a given rule includes detecting if an input parameter for the first API endpoint includes a JavaScript Object Notation (JSON) Web Token (JWT).

In a fifth rule embodiment, a given rule includes detecting if an input parameter for the first API endpoint includes an authentication token.

In a sixth rule embodiment, a given rule includes detecting if an input parameter for the first API endpoint includes a text string having high entropy.

In a seventh rule embodiment, a given rule includes detecting if an input parameter for the first API references a user or a group of users of the software application.

In an eighth first rule embodiment, a given rule includes detecting if an input parameter for the first API references a data object or a group of data objects in the software application.

In a ninth rule embodiment, the first given API endpoint includes a schema having a path, and wherein a given rule includes detecting that the path accesses a unique data object in the software application.

In a supplemental embodiment, detecting the first API endpoint includes applying a large language model classifier to the specification.

In one embodiment, the user information includes sensitive data.

In another embodiment, issuing the alert when the simulated attack is found to have been successful includes analyzing, using a large language model classifier, calls to the API endpoints and their respective responses while simulating the attack.

There is also provided, in accordance with an embodiment of the present invention, an apparatus for identifying a vulnerability in a software application, the apparatus including a memory configured to store the software application, and a processor configured to receiving a specification of a plurality of application programming interface (API) endpoints in the software application, to detect a first API endpoint of the software application that exposes user information, to identify in the software application an execution path including an ordered sequence of two or more of the API endpoints, the ordered sequence starting with a second API endpoint and ending with the first API endpoint, to simulate an attack on the software application that exploits the identified execution path, and to issue an alert when the simulated attack is found to have been successful.

There is additionally provided, in accordance with an embodiment of the present invention, a computer software product for identifying a vulnerability in a software application, the computer software product including a non-transitory computer-readable medium, in which program instructions are stored, which instructions, when read by a computer, cause the computer to receive a specification of a plurality of application programming interface (API) endpoints in the software application, to detect a first API endpoint of the software application that exposes user information, to identify in the software application an execution path including an ordered sequence of two or more of the API endpoints, the ordered sequence starting with a second API endpoint and ending with the first API endpoint, to simulate an attack on the software application that exploits the identified execution path, and to issue an alert when the simulated attack is found to have been successful.

### BRIEF DESCRIPTION OF THE DRAWINGS

The disclosure is herein described, by way of example only, with reference to the accompanying drawings, wherein:

FIG. 1 is a block diagram showing an example of a security workstation that is configured to detect a BOLA vulnerability in application programming interface (API) endpoints in a software application, in accordance with an embodiment of the present invention;

FIG. 2 is a block diagram showing data components of a dependency record used by the security workstation, in accordance with an embodiment of the present invention;

FIG. 3 is a block diagram showing data components of a tree record used by the security workstation, in accordance with an embodiment of the present invention;

FIG. 4 is a block diagram showing data components of a path record used by the security workstation, in accordance with an embodiment of the present invention;

FIG. 5 is a flow diagram that schematically illustrates a method for detecting a BOLA vulnerability comprising a potentially vulnerable endpoint (PVE) in a software application, in accordance with an embodiment of the present invention;

FIG. 6 schematically shows an example of API endpoint dependencies in a software application, in accordance with an embodiment of the present invention;

FIG. 7 schematically shows an example of a dependency tree derived from endpoint dependencies, in accordance with an embodiment of the present invention;

FIG. 8 schematically shows an example of producer-consumer pairs in the dependency tree, in accordance with an embodiment of the present invention;

FIG. 9 schematically shows, an example of execution paths to a potentially vulnerable endpoint (PVE) in the dependency tree, in accordance with an embodiment of the present invention; and

FIG. 10 is an example of a test script that the security workstation can execute so as to attempt to exploit a detected BOLA vulnerability, in accordance with an embodiment of the present invention.

### DETAILED DESCRIPTION OF EMBODIMENTS

Embodiments of the present invention provide methods and systems for detecting a vulnerability in a software application to an attack such as a BOLA attack. As described hereinbelow, a specification of a plurality of application programming interface (API) endpoints in the software application is received.

Upon detecting a first API endpoint of the software application that exposes user information (that may comprise sensitive data), an execution path comprising an ordered sequence of two or more of the API endpoints is identified in the software application. In embodiments herein, the ordered sequence starts with a second API endpoint and ends with the first API endpoint.

An attack application that exploits the identified execution path is simulated on the software, and finally an alert is issued when the simulated attack is found to have been successful.

Using embodiments described hereinbelow, systems implementing embodiments of the present invention can perform a comprehensive BLOA detection analysis on a software application by identifying one or more potentially vulnerable endpoints (PVEs), identifying one of more execution paths to each of the identified PVEs, generating multiple test shell scripts that attempt to exploit each of the execution paths, and executing the shell scripts so as to detect any BOLA vulnerabilities in the software application.

### System Description

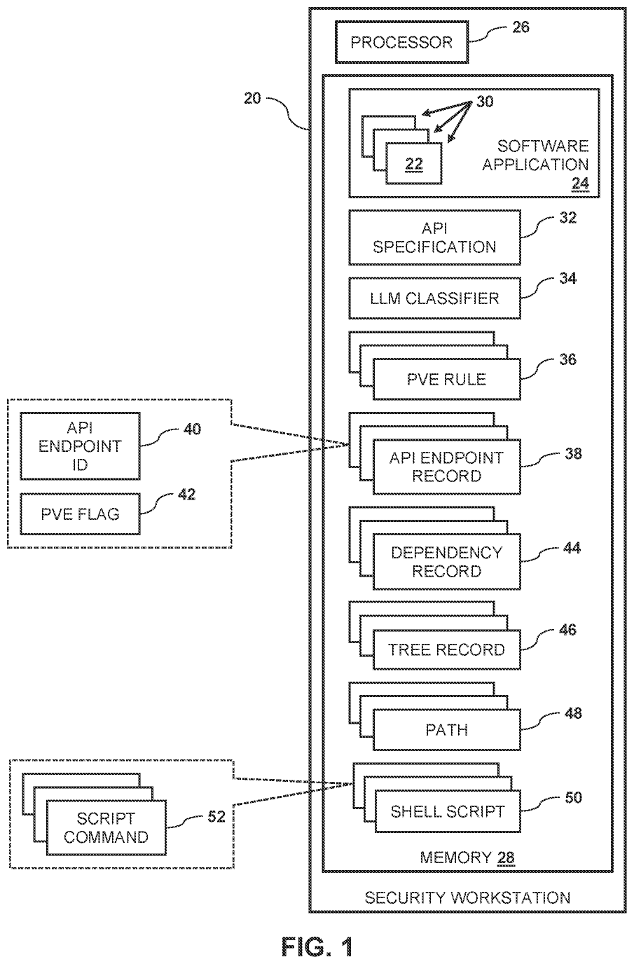

FIG. 1 is a block diagram showing an example of a security workstation 20 that is configured to detect a BOLA vulnerability in application programming interface (API) endpoints 22 of a software application 24, in accordance with an embodiment of the present invention.

In the configuration shown in FIG. 1, security workstation 20 comprises a processor 26 and a memory 28. In addition to storing software application 24 comprising API endpoints 22 that have respective API endpoint IDs 30, memory 28 can also comprise (i.e., store) an API specification 32 that comprises a machine-readable interface definition language for describing and consuming (i.e., specifying required inputs to) the API endpoints in software application 24. In some embodiments API specification 32 may comprise an OpenAPI specification (also known as a Swagger specification) for software application 24.

Memory 28 may also comprise a large language model (LLM) classifier 34 that processor 26 can use to analyze API specification 32, as described hereinbelow.

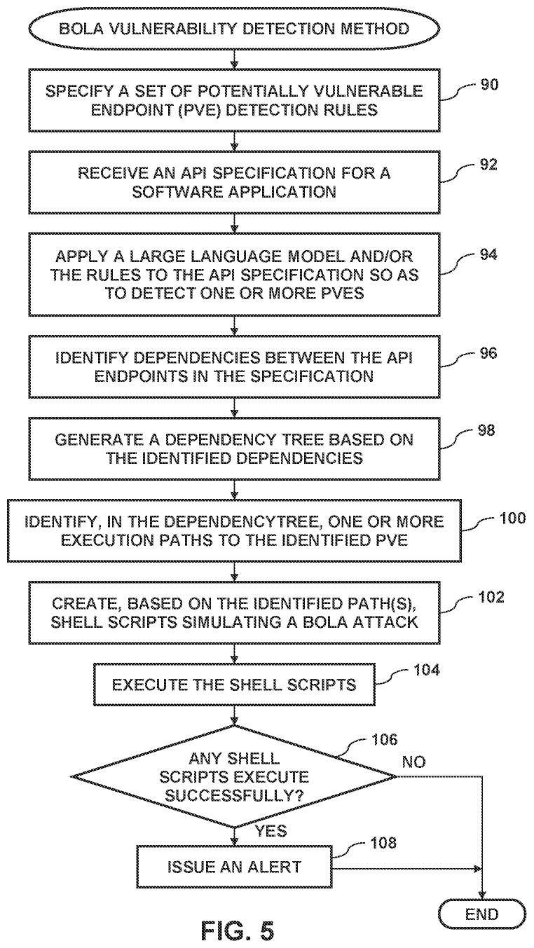

Memory 28 may additionally comprise a set of potentially vulnerable endpoint (PVE) rules 36. In some embodiments, processor 26 can analyze, using PVE rules 36, API specification 32 so as to identify any API endpoints 22 that can access, store, expose or process user information. In embodiments herein, these identified API endpoints 22 may also be referred to as PVEs 22. PVEs are typically critical to the functionality of software application 24, and therefore tend to be the most likely to be targeted by an attacker, as exploiting these endpoints typically has the most serious impacts and security implications. Some examples of PVE rules 32 are described in the description referencing FIG. 5 hereinbelow.

In some embodiments, memory 28 may further comprise a set of API endpoint records 38 that have a one-to-one correspondence with API endpoints 22. In these embodiments, for each given API endpoint 22, processor 26 can define a corresponding API endpoint record 38 that can store information such as:
An API endpoint ID 40 comprising API endpoint ID 30 for the given API endpoint.
A PVE flag 42 that processor 26 can set upon identifying (e.g., using PVE rules 36 and/or LLM classifier 34) the given API endpoint as a given PVE endpoint 22.

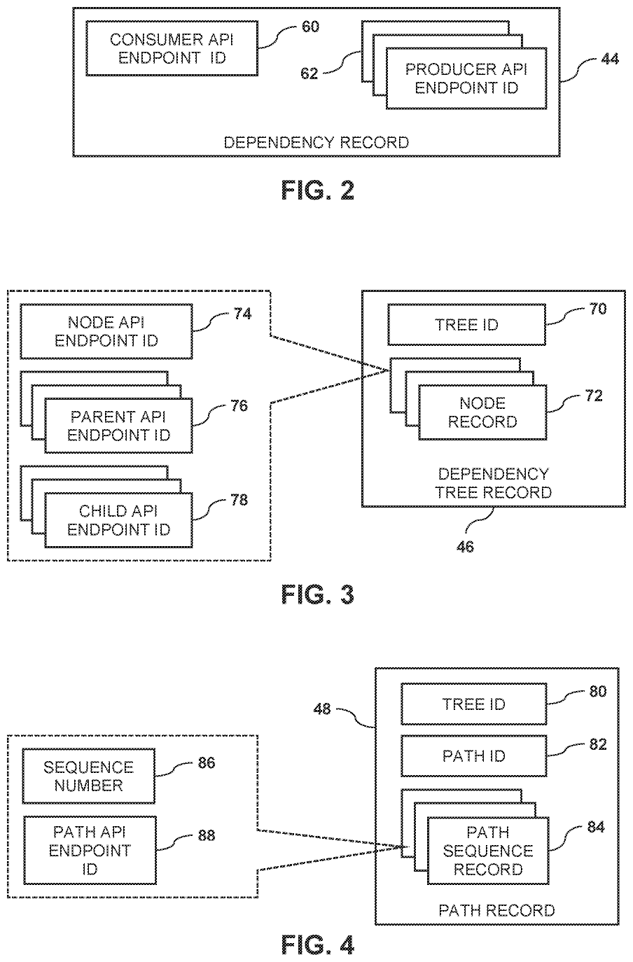

In the configuration shown in FIG. 1, memory 28 also comprises respective sets of dependency records 44, dependency tree records 46, path records 48 that are respectively described in the descriptions referencing FIGS. 2, 3 and 4 hereinbelow. In embodiments, described hereinbelow, processor 26 can use information stored in dependency records 44, dependency tree records 46, and path records 48 so as to detect any BOLA vulnerabilities in software application 24.

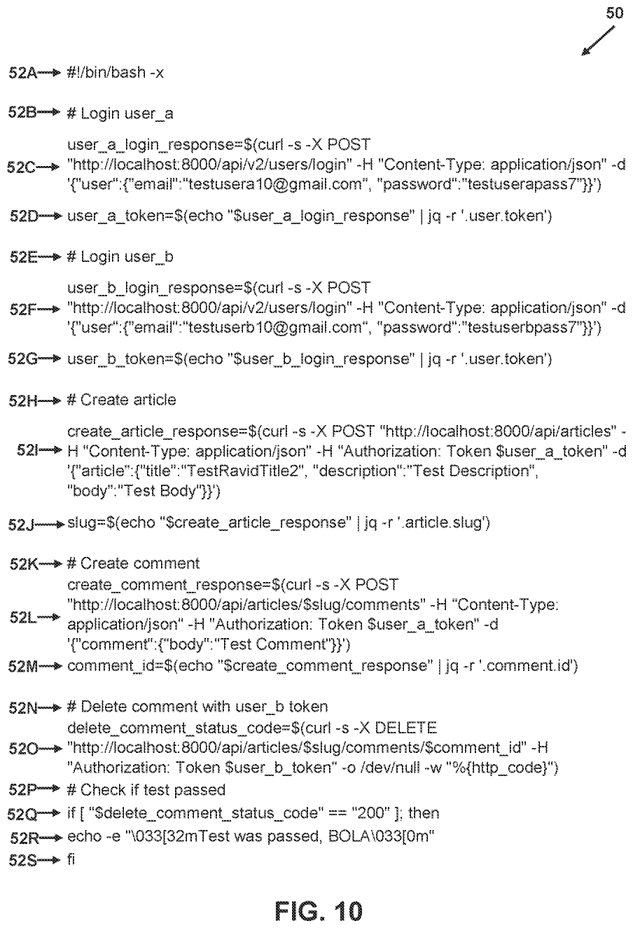

Memory 26 may additionally comprise a set of test shell scripts 50 comprising respective sets of script commands 52. embodiments described hereinbelow, upon processor 26 detecting a BOLA vulnerability in software application 24, processor 26 can generate one or more test shell scripts 50 whose respective script commands 52 attempt to exploit the detected BOLA vulnerability. In some embodiments, test shell scripts 50 may comprise Bourne-Again Shell (BASH) scripts. An example of a given test shell script 50 is described in the description referencing FIG. 10 hereinbelow.

FIG. 2 is a block diagram showing an example of a given decision dependency record 44, in accordance with an embodiment of the present invention. In the configuration shown in FIG. 2, each given dependency record 44 comprises a consumer API endpoint ID 60 comprising a first API endpoint ID referencing its respective API endpoint 22. Each given dependency record 44 may also comprise one or more producer API endpoint IDs 62 comprising respective second API endpoint ID(s) referencing their respective API endpoint(s) 22. Note that some consumer API endpoints 22 may not need (i.e., to be paired with) any producer API endpoints 22 since they can be called directly.

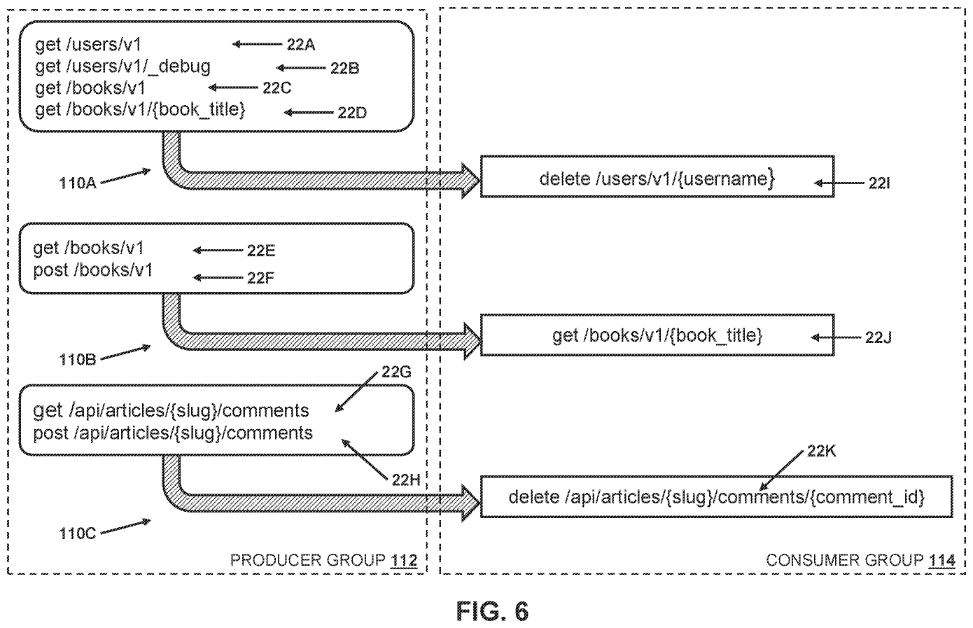

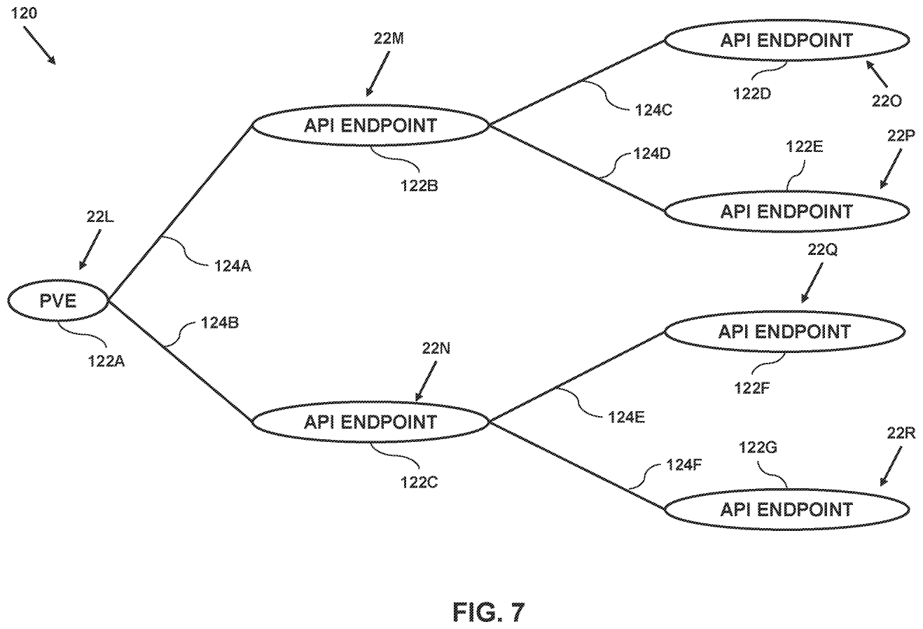

In embodiments described herein, a given second API endpoint 22 (also referred to herein as a producer API endpoint) generates (i.e., produces) output that the first given API (also referred to herein as a producer API endpoint) uses (i.e., consumes) as an input parameter. Examples of producer and consumer API endpoints are described in the description referencing FIGS. 6 and 7 hereinbelow.

FIG. 3 is a block diagram showing an example of a given dependency tree record 46, in accordance with an embodiment of the present invention. As described hereinbelow, processor 26 can generate, based on dependencies stored in dependency records 44, one or more dependency trees comprising respective sets of nodes referencing respective API endpoints 22, and can store information for each dependency tree in a corresponding dependency tree record 46. An example of a given dependency tree is described in the description referencing FIG. 7 hereinbelow.

In the configuration shown in FIG. 3, each given dependency tree record 46 can store information such as a tree ID 70 referencing the corresponding dependency tree, and a set of node records 72 corresponding to the nodes in the corresponding dependency tree. Each given node record 72 can store information for a given node such as:
A node API endpoint ID 74 comprising the API endpoint ID 30 for the corresponding API endpoint 22.
One or more parent API endpoint IDs 76 comprising the API endpoint ID(s) 30 for the corresponding API endpoint(s) 22 in any (direct) parent nodes of the given node.
One or more child API endpoint IDs 78 comprising the API endpoint ID(s) 30 for the corresponding API endpoint(s) 22 in any (direct) child nodes of the given node.

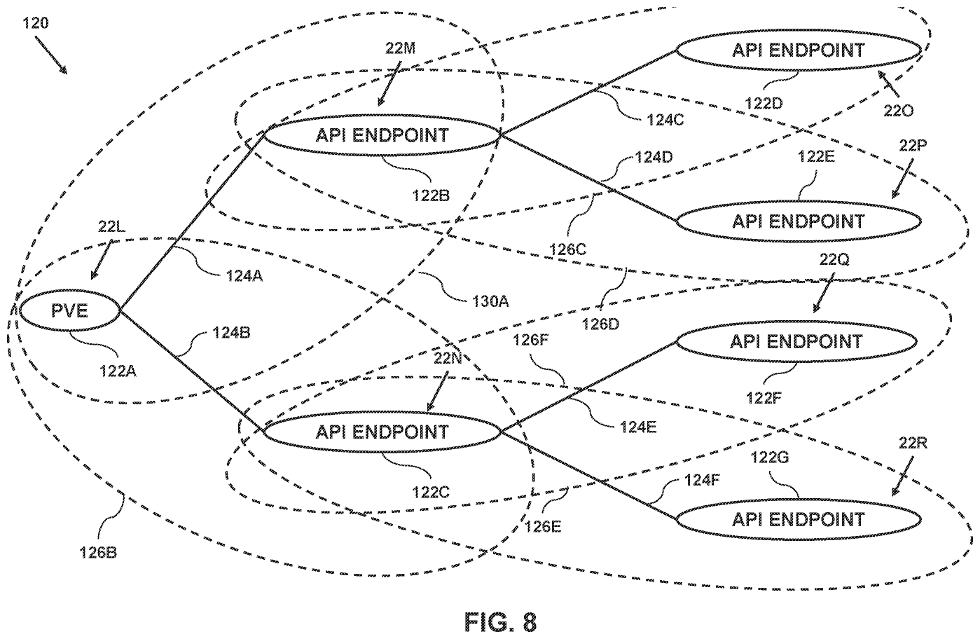

FIG. 4 is a block diagram showing an example of a given path record 48, in accordance with an embodiment of the present invention. In embodiments herein, each path record 48 describes a corresponding path that traverses a given dependency tree. Examples of paths are described in the description referencing FIG. 8 hereinbelow.

Each given path record 48 can store information such as a tree ID 80, a path ID 82, and a set of path sequence records 84. For each path record 48 corresponding to a given path in a given tree, tree ID 80 comprises tree ID 70 referencing the corresponding tree, and path ID 82 references the given path.

The given path comprises an ordered sequence of nodes referencing corresponding API endpoints 22. Path sequence records 84 in a given path record 48 for a given path correspond to the API endpoints 22 in the given path, and each path sequence record 84 can store information such as:
A sequence number 86 indicating a position of the corresponding API endpoint in the ordered sequence. For example, if the corresponding API endpoint is the first API endpoint 22 in the ordered sequence, then its sequence number 86 is 1, if the corresponding API endpoint is the second API endpoint 22 in the ordered sequence, then its sequence number 86 is 2, and so on.
An API endpoint ID 88 comprising a given API endpoint ID 30 referencing the corresponding API endpoint 22.

Processor 26 comprises one or more general-purpose central processing units (CPU) or special-purpose embedded processors, which are programmed in software or firmware to carry out the functions described herein. This software may be downloaded to security workstation 2—in electronic form, over a network, for example. Additionally or alternatively, the software may be stored on tangible, non-transitory computer-readable media, such as optical, magnetic, or electronic memory media. Further additionally or alternatively, at least some of the functions of processor 26 may be carried out by hard-wired or programmable digital logic circuits.

Examples of memory 28 include dynamic random-access memories and non-volatile random-access memories.

In some embodiments, tasks described herein performed by processor 26 may be split among multiple physical and/or virtual computing devices. In other embodiments, these tasks may be performed in a managed cloud service.

### Bola Vulnerability Detection

FIG. 5 is a flow diagram that schematically illustrates a method of detecting a BOLA vulnerability in software application 24, in accordance with an embodiment of the present invention.

In step 90, processor 26 specifies (e.g., loads to memory 28) PVE rules 36. The following are examples of conditions for PVE rules 36 that processor 26 can use for classifying a given API endpoint 22 as a PVE (i.e., the processor can classify the given API endpoint as a PVE if one or more of the following conditions are met):
Detecting that an input parameter for the given API endpoint comprises a universally unique identifier (UUID), a globally unique identifier (GUID, a session ID, a JavaScript Object Notation (JSON) Web Token (JWT), an authentication token, or a text string having high entropy. A text string with high entropy may be an indicator of a randomly generated cryptographic key since it is close to random noise (i.e., has low repetition).
Detecting that an input parameter for the given API endpoint comprises user information that can be used to reference an existing user of the software application. Examples of these input parameters include a phone number, a Social Security Number (SSN), an email address, a passport number, a username, a user ID, an employee ID, and an account number.
Detecting that an input parameter for the given API endpoint can be used to reference a group of users of the software application. Examples of these input parameters include a group number, a group name, a role name, a team ID, a user tier, an organization ID, and a department ID.
Detecting that an input parameter for the given API endpoint can be used to uniquely identify an existing data object in the software application. Examples of these input parameters include a trip ID, a ticket ID, a post ID, a message ID, a video ID, an order number, and a secret.
Detecting that an input parameter for the given API endpoint can be used to uniquely identify an existing group of data objects in the software application. Examples of these input parameters include a video playlist, a photo album, a shopping list, and a file folder.
Detecting, for an input parameter for the given API endpoint, a schema of the parameter and its path, that the path accesses (e.g., get, post, or delete) a unique data object in the system. Examples include a GET request that returns a single photo, a POST request that updates a message, or a delete request that removes an item in a shopping cart.

In step 92, processor 26 received API specification 32 for API endpoints 22 in software application 24.

In step 94, processor 26 analyzes API specification 32 so as to detect one or more API endpoint 22s that are PVEs. The given endpoint may also be referred to herein as a PVE API endpoint 22. In a first embodiment, processor 26 can perform this analysis by applying PVE rules 36 to API specification 32. In a second embodiment, processor 26 can perform this analysis by applying LLM classifier 34 to API specification 32. In the second embodiment, PVE rules 36 can provide high-level directions and examples for LLM classifier 34.

In embodiments herein, PVEs are not only API endpoints 22 that expose sensitive data in software application 24, but also include the API endpoints that operate on data associated with specific users (i.e., user information). For example, processor 26 can classify a given API endpoint 22 that processes an order_id parameter (i.e., an order identifier) for a given user is a given PVE, even though order_id does not comprise sensitive information.

When performing step 94, processor 26 can identify parameters that are unique identifiers, such as user id, email address, order_id, and team id. While these parameters may not comprise sensitive information, they can serve as indicators that there may be sensitive information in output (i.e., a response) from a given API endpoint 22.

In step 96, processor 26 applies LLM classifier 34 to API specification 32 so as to identify dependencies between API endpoints 22 in software application 24. In embodiments herein, a given dependency comprises one or more producer API endpoints 22 for a given consumer API endpoint 22.

FIG. 6 schematically shows an example of API endpoint dependencies 110 in software application 24, in accordance with an embodiment of the present invention. In the example shown in FIG. 6, dependencies 110 and API endpoints 22 can be differentiated by appending a letter to the identifying numeral, so that the dependencies comprise dependencies 110A-110C and the API endpoints comprise API endpoints 22A-22K.

In the example shown in FIG. 6:
Dependency 110A comprises producer API endpoints 22A-22D for consumer API endpoint 221.
Dependency 110B comprises producer API endpoints 22E-22F for consumer API endpoint 22J.
Dependency 110C comprises producer API endpoints 22G-22H for consumer API endpoint 22K.

In this example, a producer group 112 comprises API endpoints 22A-22H (i.e., the producer API endpoints), and producer group 114 comprises API endpoints 221-22K (i.e., the consumer API endpoints).

While the example shown in FIG. 6 shows a single level of endpoint dependencies, there may be multiple levels of endpoint dependencies. For example, producer API endpoints 22A-22G in producer group 110 may also be consumer API endpoints 22 that “consume” from other producer API endpoints 22 (e.g., post/articles and get/articles).

Returning to the flow diagram, in step 98, processor 26 generates a dependency tree based on the dependencies identified in step 96.

FIG. 7 schematically shows an example of a dependency tree 120 comprising nodes 122 and edges 124 that processor 26 derived from endpoint dependencies 110, in accordance with an embodiment of the present invention.

In the example shown in FIG. 7 (and in FIG. 8, as described hereinbelow), nodes 122, edges 124 and API endpoints 22 can be differentiated by appending a letter to the identifying numeral, so that the nodes comprise nodes 122A-122G, the edges comprise edges 124A-124F, and the API endpoints comprise API endpoints 22L-22R.

In dependency tree 120, edge 124A (directly) connects nodes 122A and 122B, edge 124B connects nodes 122A and 122C, edge 124C connects nodes 122B and 122D, edge 124D connects nodes 122B and 122E, edge 124E connects nodes 122C and 122F, and edge 124F connects nodes 122C and 122G. Additionally:
Root node 122A corresponds to API endpoint 22L, and has child nodes 122B and 122C.
Node 122B corresponds to API endpoint 22M, has parent node 122A, and has child nodes 122D and 122E.
Node 122C corresponds to API endpoint 22N, has parent node 122A, and has child nodes 122F and 122G.
Leaf node 122D corresponds to API endpoint 220, and has parent node 122B.
Leaf node 122E corresponds to API endpoint 22P, and has parent node 122B.
Leaf node 122D corresponds to API endpoint 220, and has parent node 122C.
Leaf node 122D corresponds to API endpoint 22R, and has parent node 122C.

FIG. 8 schematically shows an example of producer-consumer pairs 130 in dependency tree 120 that processor 26 derived from endpoint dependencies 110, in accordance with an embodiment of the present invention. In some embodiments, processor 26 can generate dependency tree 120 based on the information stored in a given tree dependency record 46.

In embodiments herein, processor 26 can group API endpoints 22 into producer-consumer pairs 130 comprising a given producer API 22 and a given consumer API 22. In the example shown in FIG. 8, producer-consumer pairs 130 can be differentiated by appending a letter to the identifying numeral, so that the producer-consumer pairs comprise producer-consumer pairs 130A-130F. In this example:
Producer-consumer pair 130A comprises API endpoint 22B as the producer API node, and API endpoint 22A as the consumer API.
Producer-consumer pair 130B comprises API endpoint 22C as the producer API, and API endpoint 22A as the consumer API.
Producer-consumer pair 130C comprises API endpoint 22D as the producer API, and API endpoint 22B as the consumer API.
Producer-consumer pair 130D comprises API endpoint 22E as the producer API, and API endpoint 22B as the consumer API.
Producer-consumer pair 130E comprises API endpoint 22F as the producer API, and API endpoint 22C as the consumer API.
Producer-consumer pair 130F comprises API endpoint 22G as the producer API, and API endpoint 22C as the consumer API.

Note that a given API endpoint 22 may be a given producer in a first producer-consumer pair 130, and a given consumer in a second producer-consumer pair 130. For example, API endpoint 22M is (a) the producer in producer-consumer pair 130A, (b) the consumer in producer-consumer pair 130B, and (c) the consumer in producer-consumer pair 130C.

Returning to the flow diagram, in step 100, processor 26 identifies one or more execution paths to the given PVE API endpoint node that the processor detected in step 94. Typically, this endpoint cannot be directly accessed in software application 24. Therefore, in embodiments of the present invention processor 26 can identify an ordered sequence of API endpoints 22 that can be used to reach the given PVE endpoint. In some embodiments, this sequence can be stored to a given path record 48.

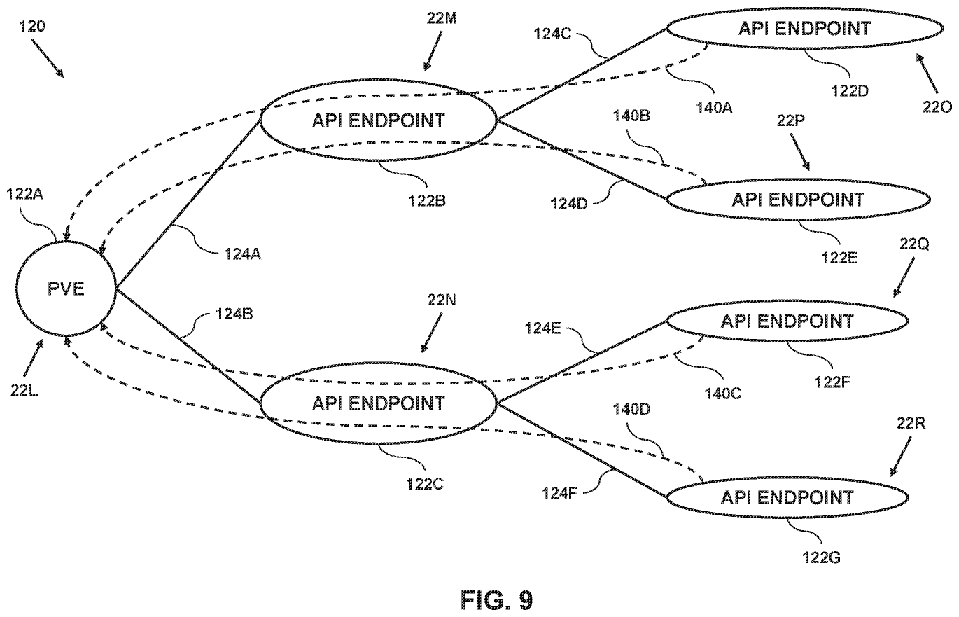

FIG. 9 schematically shows an example of execution paths 140 to PVE API endpoint 22A in dependency tree 120, in accordance with an embodiment of the present invention. In embodiments herein, paths 140 expose BOLA vulnerabilities in software application 24.

In the example shown in FIG. 9, execution paths 140 can be differentiated by appending a letter to the identifying numeral, so that the execution paths comprise execution paths 140A-140D. In this example:
The ordered sequence of execution path 140A comprises:
   a. Node 122D corresponding to API endpoint 220.
   b. Node 122B corresponding to API endpoint 22M.
   c. Node 122A corresponding to API endpoint 22L.
The ordered sequence of execution path 140B comprises:
   a. Node 122E corresponding to API endpoint 22P.
   b. Node 122B corresponding to API endpoint 22M.
   c. Node 122A corresponding to API endpoint 22L.
The ordered sequence of execution path 140C comprises:
   a. Node 122F corresponding to API endpoint 22Q.
   b. Node 122C corresponding to API endpoint 22N.
   c. Node 122A corresponding to API endpoint 22L.
The ordered sequence of execution path 140D comprises:
   a. Node 122G corresponding to API endpoint 22R.
   b. Node 122C corresponding to API endpoint 22N.
   c. Node 122A corresponding to API endpoint 22L.

The following is an example of execution path 140A.

Start with PVE endpoint 220:
delete /api/articles/{slug}/comments/{comment_id}

This endpoint allows a first user to delete a comment the first user made on an article/slug. Endpoint 220 can be vulnerable to BOLA because if the API server (not shown) does not correctly verify the caller, this may allow a second user (different from the first user) to delete the first user's comment. A call TO endpoint 220 requires two input parameters (a) {slug} and (b) {comment_id}. The values of these parameters need to be obtained from other API endpoints 22.

One of the API endpoints that can provide the available article/slug is
get /api/articles

With the article/slug, the next step is to obtain the list of its comments (and their comment_id). One of the API endpoints that can provide the comments of a specific article/slug is
get /api/articles/{slug}/comments

With the valid article/slug and comment_id, PVE API endpoint 220 can now be called. Mapping back to path 140A:
API endpoint 22L comprises
   delete /api/articles/{slug}/comments/{comment_id}
API endpoint 22M comprises
   get /api/articles/{slug}/comments
API endpoint 220 comprises
   get /api/articles

Using this example, execution path 140A comprises the following ordered sequence of API endpoints 22:
a. Node 122D referencing first API endpoint 220.
b. Node 122B referencing second API endpoint 22M.
c. Node 122A referencing third API endpoint 22L.

Returning to the flow diagram, in step 102, processor 26 uses LLM classifier 34 to generate shell scripts 50 that attempt to simulate BOLA attacks by exploiting the detected BOLA vulnerabilities.

FIG. 10 is an example of a given test shell script 50 comprising a BASH script that processor 26 can execute so as to attempt to exploit a detected BOLA vulnerability in software application 24, in accordance with an embodiment of the present invention. In the example shown in FIG. 9, script commands 52 can be differentiated by appending a letter to the identifying numeral, so that the script commands comprise script commands 52A-52F.

In this example: (a) a first user “UserA” creates an article, (b) UserA creates a comment for the article, and (c) A second user “UserB” deletes the comment of UserA.

These steps are performed in the given test scripts as follows:
In script commands 52C-52D, UserA logs in to software application 24 using its credentials (already registered), gets a first token in the response, and the first token is extracted and saved as “user_a_token”.
In script commands 52F-52G, UserB logs in to the software application 24 its credentials (already registered), gets a second token in the response, and the second token is being extracted and saved as “user_b_token”.
In script commands 521-52J, UserA creates an article in software application 24 (using “user_a_token”), and the article name (slug) is extracted and saved as “slug”.
In script commands 52L-52M, UserA creates a comment for the article “slug” (using “user_a_token”), and the comment_id is extracted and saved as “comment_id”.
In script command 520, UserB initiates a BOLA attack by attempting to delete the comment “comment_id” in “slug” (using “user_b_token”). The comment belongs to UserA.

Returning to the flow diagram, in step 104, processor 26 executes the test shell scripts so as to simulate a series of BOLA attacks on software application 24.

In step 106, processor 26 analyzes the execution of tests scripts 50 so as to detect if software application 24 successfully executed any of the test scripts, thereby indicating a BOLA vulnerability. In some analysis embodiments, processor 26 can perform step 106 by using LLM classifier 34 to analyze the responses from API endpoints 22 when using test scripts 50 to execute software application 24. In one analysis embodiment, LLM classifier 24 can inspect the content of the responses in order to check whether the aligns with expected behavior (i.e., of the API endpoints). In another analysis embodiment, LLM classifier 24 can analyze detailed information about the API endpoint requests (i.e., calls) and responses so as to verify validity of the requests and responses.

In the example described hereinabove (i.e., in step 102):
In script commands 52R-52S, processor 26 checks a status code for “delete comment status code”, which is the BOLA attempt described supra.
In case the attack was successful processor 26 can classify the endpoint (DELETE API “http://localhost: 8000/api/articles/$slug/comments/$com ment_id” in this case) is potentially vulnerable to BOLA.

If processor 26 detects that software application 24 successfully executed any of test scripts 50, then in step 108, the processor issues an alert (i.e., generate a notification that software application 24 is vulnerable to a BOLA attack), and the method ends.

Returning to step 106, if processor 26 detects that software application 24 did not successfully execute any of the test scripts, then no further action needs to be taken, and the method ends.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method for identifying a vulnerability in a software application, the method comprising:
receiving a specification of a plurality of application programming interface (API) endpoints in the software application;
detecting a first API endpoint of the software application that exposes user information;
identifying in the software application an execution path comprising an ordered sequence of two or more of the API endpoints, the ordered sequence starting with a second API endpoint and ending with the first API endpoint;
simulating an attack on the software application that exploits the identified execution path; and
issuing an alert when the simulated attack is found to have been successful.

2. The method according to claim 1, wherein the vulnerability comprises a vulnerability to broken object level authorization (BOLA) attacks, and wherein the attack comprises a given BOLA attack.

3. The method according to claim 1, wherein the specification comprises an OpenAPI specification.

4. The method according to claim 1, wherein identifying the execution path comprises identifying, in the specification, dependencies between the API endpoints, generating a dependency tree based on the identified dependencies, and identifying the execution path in the dependency tree.

5. The method according to claim 4, wherein identifying the dependencies comprises applying a large language model classifier to the specification.

6. The method according to claim 1, wherein simulating the attack comprises generating a shell script for the software application that simulates the attack, and executing the shell script.

7. The method according to claim 1, wherein detecting the first API endpoint comprises applying a set of rules to the specification, and detecting that a given rule applies to the first API endpoint.

8. The method according to claim 7, wherein a given rule comprises detecting if an input parameter for the first API endpoint comprises a universally unique identifier.

9. The method according to claim 7, wherein a given rule comprises detecting if an input parameter for the first API endpoint comprises a globally unique identifier.

10. The method according to claim 7, wherein a given rule comprises detecting if an input parameter for the first API endpoint comprises a session ID.

11. The method according to claim 7, wherein a given rule comprises detecting if an input parameter for the first API endpoint comprises a JavaScript Object Notation (JSON) Web Token (JWT).

12. The method according to claim 7, wherein a given rule comprises detecting if an input parameter for the first API endpoint comprises an authentication token.

13. The method according to claim 7, wherein a given rule comprises detecting if an input parameter for the first API endpoint comprises a text string having high entropy.

14. The method according to claim 7, wherein a given rule comprises detecting if an input parameter for the first API references a user or a group of users of the software application.

15. The method according to claim 7, wherein a given rule comprises detecting if an input parameter for the first API references a data object or a group of data objects in the software application.

16. The method according to claim 7, wherein the first given API endpoint comprises a schema having a path, and wherein a given rule comprises detecting that the path accesses a unique data object in the software application.

17. The method according to claim 1, wherein detecting the first API endpoint comprises applying a large language model classifier to the specification.

18. The method according to claim 1, wherein the user information comprises sensitive data.

19. The method according to claim 1, wherein issuing the alert when the simulated attack is found to have been successful comprises analyzing, using a large language model classifier, calls to the API endpoints and their respective responses while simulating the attack.

20. An apparatus for identifying a vulnerability in a software application, the apparatus comprising:
a memory configured to store the software application; and
a processor configured:
to receiving a specification of a plurality of application programming interface (API) endpoints in the software application,
to detect a first API endpoint of the software application that exposes user information,
to identify in the software application an execution path comprising an ordered sequence of two or more of the API endpoints, the ordered sequence starting with a second API endpoint and ending with the first API endpoint,
to simulate an attack on the software application that exploits the identified execution path, and
to issue an alert when the simulated attack is found to have been successful.

21. A computer software product for identifying a vulnerability in a software application, the computer software product comprising a non-transitory computer-readable medium, in which program instructions are stored, which instructions, when read by a computer, cause the computer:
to receive a specification of a plurality of application programming interface (API) endpoints in the software application;
to detect a first API endpoint of the software application that exposes user information;
to identify in the software application an execution path comprising an ordered sequence of two or more of the API endpoints, the ordered sequence starting with a second API endpoint and ending with the first API endpoint;
to simulate an attack on the software application that exploits the identified execution path; and
to issue an alert when the simulated attack is found to have been successful.
